(19) United States
(12) Patent Application Publication
(10) Pub. No.: US 2013/0325723 A1
(43) Pub. Date: Dec. 5, 2013

(54) GROUP FUNDING PLATFORMS AND RELATED TECHNIQUES

(71) Applicant: Crowdtilt, Inc., San Francisco, CA (US)

(72) Inventors: Khaled Hussein, San Francisco, CA (US); James Beshara, San Francisco, CA (US)

(21) Appl. No.: 13/909,626

(22) Filed: Jun. 4, 2013

Related U.S. Application Data
(60) Provisional application No. 61/655,368, filed on Jun. 4, 2012.
(60) Provisional application No. 61/722,457, filed on Nov. 5, 2012.
(60) Provisional application No. 61/772,630, filed on Mar. 5, 2013.

(51) Int. Cl. G06Q 20/40

(52) U.S. Cl. CPC G06Q 20/405
USPC 705/44

(57) ABSTRACT

A variety of techniques are described herein for facilitating group funding in a network computing environment.

### RELATED APPLICATION DATA

The present application claims priority under 35 U.S.C. 119(e) to U.S. Provisional Patent Application No. 61/655,368 entitled Group Payment Process and System filed Jun. 4, 2012 (Attorney Docket No. 43854-8001), and to U.S. Provisional Patent Application No. 61/722,457 entitled Crowd Funding API filed Nov. 5, 2012 (Attorney Docket No. CRWDP001P), and to U.S. Provisional Patent Application No. 61/772,630 entitled Crowd Funding API filed Mar. 5, 2013 (Attorney Docket No. CRWDP001P2), the entire disclosures of which are incorporated herein by reference for all purposes.

### BACKGROUND

Generally speaking, a group funding application (typically operating in a distributed network context such as the Internet) collects money from one or more entities (e.g., individuals or organizations) and then distributes the collected money to one or more entities. Examples of group funding applications include one where people fundraise for a nonprofit organization or a political campaign; fans raise money to pay a struggling musician's medical bills; a group of friends pool their money together to rent a vacation home or planning a bachelor party, and what is commonly known as crowd funding where an entrepreneur tries to fund a startup company; etc. The diverse nature of such applications is apparent. And while the group funding industry is still in its early stages, a variety of platforms are thriving in the marketplace.

### BRIEF DESCRIPTION OF THE DRAWINGS

FIG. 1 is a simplified diagram of a computing environment in which various implementations may be provided.

FIG. 2 is a flow diagram illustrating an example of an implementation of a group funding platform.

FIG. 3 is a simplified diagram illustrating operation of a particular class of implementations of a group funding platform.

### DETAILED DESCRIPTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, those of skill in the art will understand that this description is not intended to limit the invention to the described embodiments. On the contrary, the Applicant intends to cover alternatives, modifications, and equivalents as may be included within the spirit and scope of the invention as defined by the appended claims. In the following description, specific details are set forth in order to provide a thorough understanding of the present invention. The present invention may be practiced without some of these specific details. In addition, well known features may not be described in detail to avoid unnecessarily obscuring the invention.

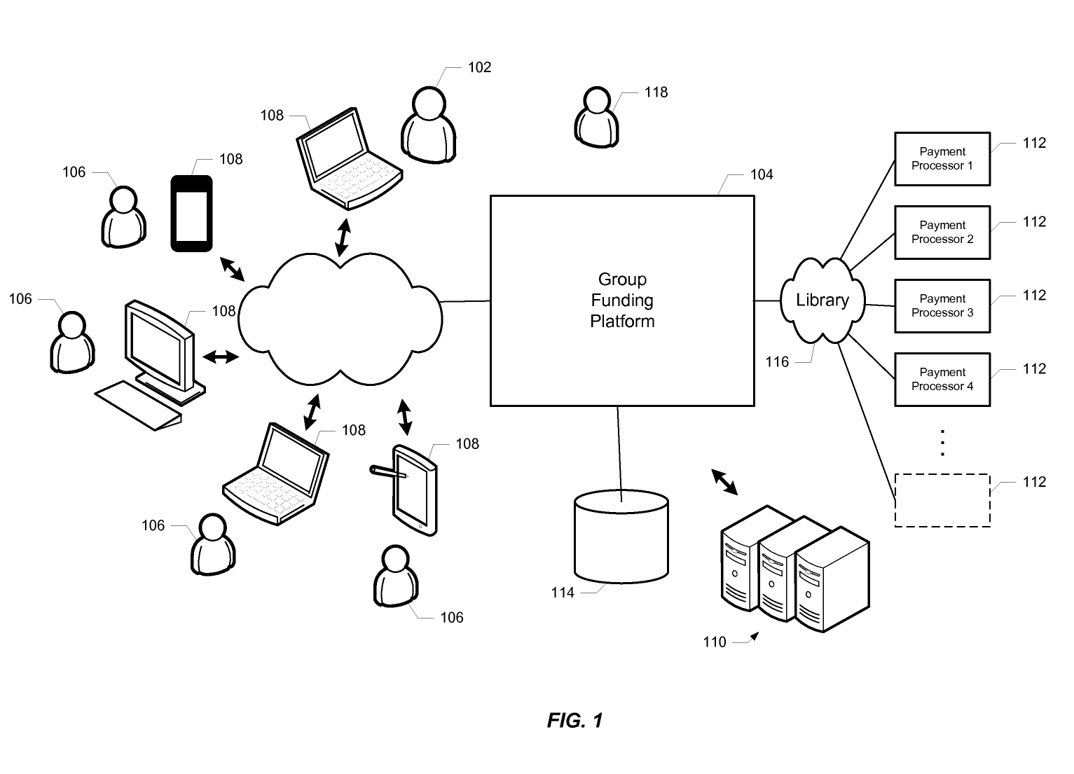

A variety of techniques are described herein for facilitating group funding in a network computing environment. As will become apparent, various implementations described herein may be characterized by advantages over conventional approaches to group or crowd funding. Referring now to FIG. 1, an example of a group funding platform will be described. As used herein “group funding platform” refers generally to a set of functionalities supporting group funding that may be implemented using one or more computing devices operating in a network computing environment. A user 102, referred to as the “admin” or “administrator,” interacts with group funding platform 104 (e.g., using any type of client device 108 to set up a “campaign” in which one or more users 106, also referred to as “contributors,” contribute money to reach a goal or target, i.e., a defined amount of money for the campaign. In support of such campaigns, group funding platform 104 also interacts with one or more payment processors 112. As is well known, there are dozens of online payment processors including, for example, Amazon, PayPal, Stripe, BrainTree, Balanced, WePay, Dwolla, etc. A group funding platform may be designed that works with one or multiple such payment processors. For example, multiple payment processors may be used to allow contributors to contribute to a single campaign in different ways. In another example, a contributor might be enabled to contribute to a campaign using one payment processor, and a beneficiary of the campaign might receive funds via another payment processor or distribution via another entity. A group funding platform may also be designed to work with various forms of payment processing, e.g., credit cards, electronic checks, or other forms of currency, e.g., virtual currency (from gaming environments or online communities, Bitcoins, etc.). Information relating to campaigns, users, and payments employed by group funding platform 104 is stored in one or more data repositories 114.

Users 106 make payments via interfaces of platform 104 (e.g., using any type of client device 108) which are mapped to an appropriate one of payment processors 112 (e.g., as described below) for authorization and/or payment. When the campaign ends (e.g., when a specified time period expires or when a specified termination trigger is met) the money is released to admin 102 or a beneficiary 118 designated by admin 102. Group funding platform 104 may be implemented using one or more computing devices such as, for examples, one or more servers 110 as illustrated.

According to a particular class of implementations, money promised to a campaign through authorizations is only settled if a specified monetary goal or “tilt amount” is reached. For example, if the specified time duration for the campaign expires without the tilt amount being reached, none of the user's pledging to contribute to the campaign are charged. A tilt amount may even be zero. On the other hand, a campaign does not necessarily end when the tilt amount is reached. For example, a tilt amount may be $5,000 for a campaign scheduled to end on March 15^{th}. Even if the tilt amount is reached on March 1^{st}, the campaign may continue and additional funds may be contributed beyond the tilt amount. Alternatively, the tilt amount or some target higher than the tilt amount (i.e., the goal amount) may be specified as what triggers termination of the campaign.

In some implementations, a campaign may be set up to accept one or more different types of contributions including fixed amounts, minimum amounts, any amount specified by the contributor, or a dynamic amount as defined by the campaign admin. Different types of contributions may be appropriate for different types of group funding. For example, fixed amounts allow for an admin to enforce specific contribution amounts. Such a capability might be useful, for example, for an event promoter to sell “tickets” (e.g., for a house concert) for one or more specific amounts (as opposed to relying on each contributor to enter an appropriate amount). In another example, a minimum amount allows the admin to ensure that anyone contributing to a campaign contributes at least the minimum. This might be useful where, for example, someone is trying to raise funds from a group of friends to purchase a birthday gift for a mutual friend. Contributors might be encouraged to contribute more than the minimum (e.g., with promises of a better gift) but they are at least required to cover some minimum cost if they plan to participate in the group gift. Allowing the contributors to select the amount they would like to contribute provides considerable flexibility. For example, such an approach might be useful in an application where it is important to facilitate participation by the greatest number of contributors, e.g., charitable giving or development. Examples of the use of dynamic pricing are provided below.

It should be understood that nature of platform 104 and the relationship of admin 102 to the application and/or the contributors may vary considerably. For example, platform 104 may be a web site, e.g., crowdtilt.com, that provides a platform that enables many unrelated campaigns to be set up and conducted by many unrelated individuals and/or groups. Alternatively, platform 104 can be a standalone application supporting only one or a relatively small number of related campaigns that is/are set up by or associated with a single individual or entity; see, for example, crowdhoster.com (provided by Crowdtilt) which allows anyone to develop and launch his or her own group funding platform. Another alternative is a third party online portal using a group funding application programming interface (API) as discussed below. More generally, a group funding platform implemented as described herein may support use cases having different types of correspondence (e.g., one-to-one, one-to-many, many-to-one and many-to-many) among the various entities involved in campaigns (e.g., admins, applications, campaigns, contributors, communities of contributors, beneficiaries, etc.). For example, a single application might support many campaigns set up by many different admins. A single admin might create and manage multiple campaigns. A single campaign might be set up to benefit multiple beneficiaries, or multiple campaigns could be set up to benefit a single beneficiary. Many contributors might be enabled to contribute to many different campaigns. Those of skill in the art will appreciate other such examples. And the computing devices with which such a platform may be implemented and by which users may access the platform may be any of a wide variety of computing devices known to those of skill in the art and suitable for a particular implementation. For example, user devices by which users might interact with such a platform include, but are not limited to, desktops, laptops, handheld devices, smart phones, tablets, wearable technology, etc. The scope of the invention should therefore not be limited with reference to particular implementations.

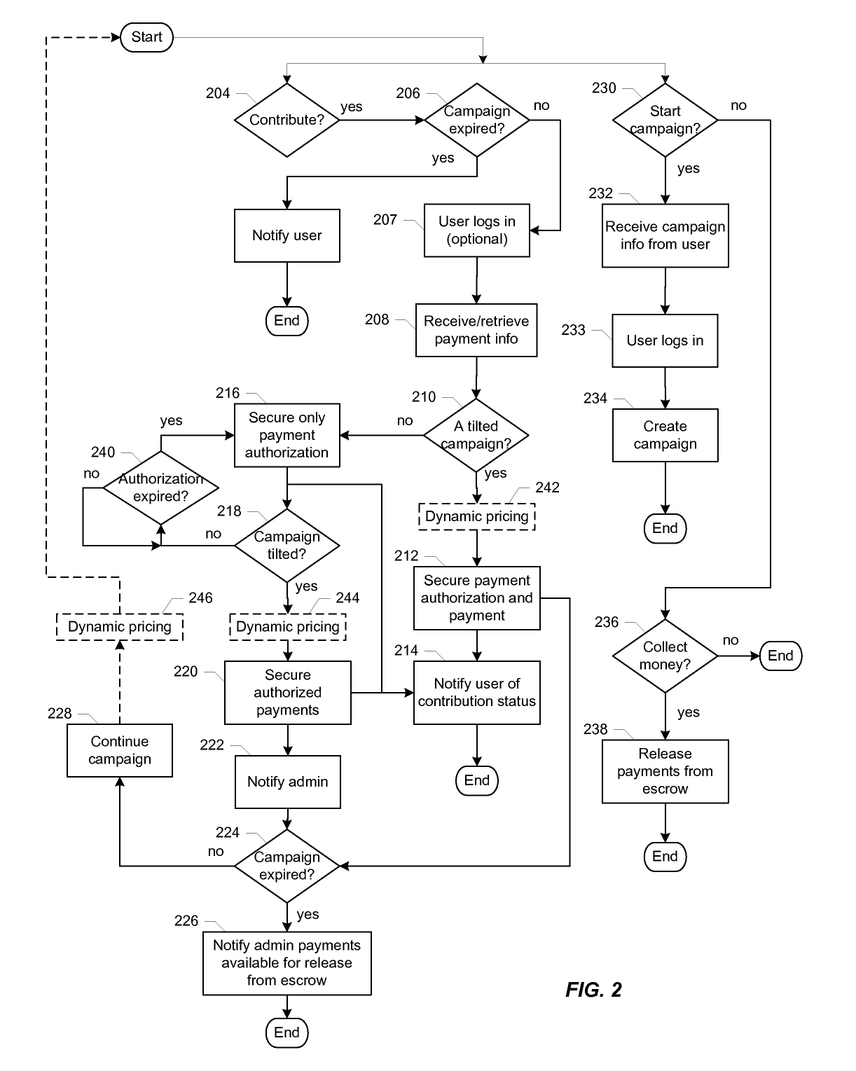

FIG. 2 is a flow diagram illustrating some of the functionalities that may be provided in a group funding platform or application as described herein. When a user (e.g., an admin or a contributor to a campaign) interacts with the platform or application she or he may, among other things, create or modify a campaign, contribute to an existing campaign, or collect accumulated funds for an existing campaign (e.g., request that the funds be released from an intermediary account after the campaign has “tilted”). It should be noted that logging into or creating an account for a group funding platform or application may be optional in that implementations are contemplated in which a user may interact with a platform or application without doing so. For example, a contributor might contribute to a campaign anonymously, or potential contributor might anonymously browse existing campaigns. In another example, a user might be allowed to begin creation of a campaign without logging in. In yet another example, a non-user can create a campaign, launch it, and accept commitments from contributors in the form of authorizations. In such a case, the contributors would be charged only after the tilt amount is reached and the campaign admin creates an account. In yet another example, a beneficiary might receive funds (e.g., into an account specified by an admin) without ever interacting with the platform. In still another example, a user might not be required to create an account, but may still have to provide some minimal information to address regulatory concerns, e.g., to verify user identity. In such a case, a returning user would be required to re-enter the information.

Referring back to FIG. 2, if the user elects to contribute to a particular campaign (204) and the campaign has not expired (206), the user (optionally) logs in (207), and the platform receives or retrieves the user's payment information (208) which might include, for example, credit card information or other suitable payment information (e.g., a PayPal account, a debit account, type of currency, etc.). A first time contributor might be presented with an interface by which the payment information may be entered, while the payment information for a returning contributor might be retrieved from the system's database. If the campaign has “tilted” (210), i.e., the campaign's tilt amount has already been reached, payment is both authorized and settled (212) and the user is notified (214). If the campaign has not yet tilted, only payment authorization (e.g., a valid authorization to charge a credit card) is secured (216) and the user may also be notified (214).

If the user's contribution tilts the campaign (218), all authorized payments are settled (220) and both the user and the admin who set up the campaign may be notified of the event (214, 222). If the campaign has expired (224), the admin may be notified that the campaign's accumulated funds are available for release (226), e.g., from a holding account, a holding account, etc. Alternatively, the funds may be automatically released to a specified account. In either case, funds may be released to any of a wide variety of account types, e.g., bank accounts, PayPal accounts, etc. Funds may be released in other ways as well. For example, a beneficiary's credit card could be credited. In another example, a prepaid payment card could be credited. In yet another example, virtual currency could be transferred to an online account.

Referring again to FIG. 2, if the campaign has not expired, the campaign continues (228). As described elsewhere herein, expiration of a campaign may be triggered by a variety of events. For example, a campaign may expire when a target amount of monetary contributions has been reached. This may be the campaign's tilt amount or may be a goal amount that exceeds the tilt amount. Alternatively, a campaign may expire after a set period of time or at a particular moment in time. As yet another alternative, a campaign may expire after a particular number of contributors have participated. Other suitable alternatives will be apparent to those of skill in the art. As also shown in FIG. 2, a user (e.g., an admin) may also interact with the platform to create a campaign (230-234), or to collect the accumulated funds for her or his campaign (236, 238). Some implementations of group funding platforms or applications employ custom code specifically written for the use cases and functionalities supported by the particular platform or application, e.g., policies for handling payments and refunds, modes of payment, authorization of payments, payment processors supported, etc. Such custom-built solutions may be suitable for the particular use cases for which they are designed, but may not be easily adapted for other use cases.

By contrast, and according to a particular class of implementations, an application programming interface (API) is provided which may be used to enable a wide variety of group funding or other commerce applications for any merchant online. The API specifies an interface among the software components of such applications that abstracts a number of functionalities in such a way to enable a more efficient approach to implementing and scaling group funding applications and services. APIs implemented as described herein enable the aggregation and queuing of transactions over multiple campaigns, users, and payment processors in a manner that facilitates the scaling of a service or application to encompass new use cases and/or modes of operation.

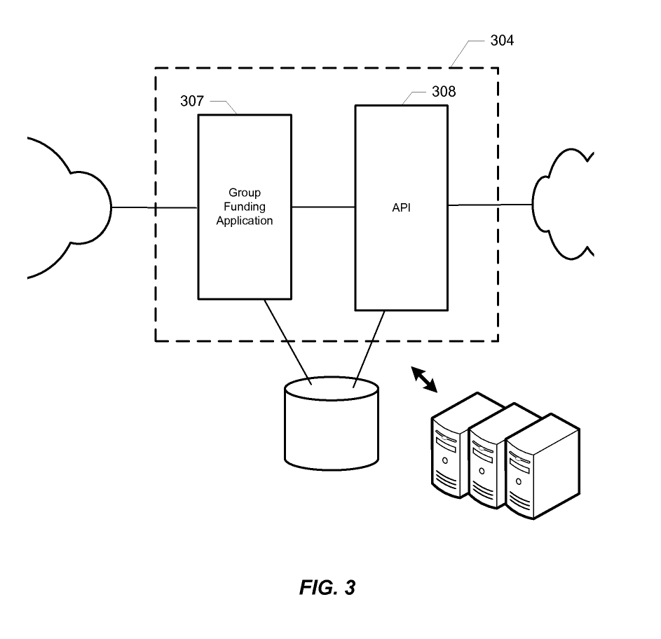

According to such an implementation illustrated in FIG. 3, a group funding platform 304 may include a group funding application 307 and an application programming interface (API) 308 that lies between group funding application 307 and the one or more payment processors. API 308 provides a layer of abstraction between application 307 and the payment processors and defines several object classes including, for example, campaign, user, payment (inbound payments, e.g., contributions, and outbound payments, e.g., payments to administrators or beneficiaries), comments, credit cards, and bank accounts. As mentioned above with reference to FIG. 1, a campaign represents a defined goal that one or more users achieve through payments. Information relating to these various objects employed by application 307 and specified using API 308 is stored in one or more data repositories (e.g., data repository 114 of FIG. 1). The layer of abstraction provided by API 308 allows the developer of a campaign (e.g., an admin) to focus on the goal of the campaign rather than the logistics of how payments and the release of funds will be achieved.

According to a particular implementation, the minimum amount of information required to create a user is a valid email address, but considerably more information may be requested, collected, and stored for a given user representing different status and/or permissions. For example, in order for a user to receive money raised from a campaign, the user's identity may need to be verified to comply with regulatory or legal requirements. In some cases, user authentication may be advisable therefore requiring some form of login or other suitable authentication credentials. The range of possibilities will be understood by those of skill in the art. It should also be noted that users may interact with a group funding platform as described herein without being a user as defined by the API. For example, as described above, an anonymous user may browse campaigns, or even contribute to a campaign without a user being created from the perspective of the API. Also as described above, a beneficiary of the funds raised by a campaign may or may not be a user in the context of the API. The beneficiary may just be the recipient beneficiary of the funds raised. In another example, a user might be registered with a third party (e.g., an online merchant) that has an application that connects with the platform. This user may have a unique user identity with the third party, and would be created as a user in the API databases, but the user object would contain a minimal amount of information about that third party's user, e.g., his or her email address, to identify them.

APIs implemented as described herein enable management of objects within pre-defined object classes, e.g., the management of objects within the user class (e.g., a Crowdtilt user or a user on another platform for which a user identity is created), the management of campaign objects within the campaign class, or the management of payment objects within the payment class. The admin setting up a campaign defines the monetary goals (which may be the tilt amount or the goal amount—which is the amount they would like to reach on the higher end) as well as a variety of other parameters including, for example, any of: the campaign duration/expiration, a target amount beyond the monetary goal at which the campaign expires, the payment processor(s), the currency, the language, the mode of release of the accumulated funds, type of payment, etc. Each user (including the admin or campaign creator) is defined by a set of attributes that sufficiently uniquely identify the user and may specify the specific campaign or campaigns with which that user is associated. According to a particular class of implementations, the API itself may include some level of permissions capability by which the activities of users are defined and controlled. For example, a user may be given administrator permissions or contributor permissions. According another class of implementations, an API integrator (e.g., an online merchant that provides group funding capacities via the API) may specify their own layer of permissions for their users.

A particular implementation of an API in which these various objects are defined is illustrated in the Crowdtilt API Specs documentation, a copy of which is attached hereto as an appendix and forms part of this disclosure. It should be understood that the described implementation is merely an example of how such an API might be specified.

Referring again to FIG. 3, API 308 has an interface with associated logic (e.g., library 116 of FIG. 1) to enable the API to correctly interface with various payment processors (e.g., payment processors 112 of FIG. 1). Library 116 abstracts the interaction with various payment processors such that group funding applications using the API can interface with the payment processors through one standardized internal-facing contract. Not all payment processors, for example, do holds the same way, or charge cards the same way Additionally, what actually occurs when payment is released to an admin (e.g., admin 102 of FIG. 1) depends on what is allowed and/or required by the payment processor associated with the campaign. Some payment processors allow debiting and deposit of funds directly from and to designated bank accounts. Still others might allow charging a credit card account.

As will be understood, API 308 may be PCI compliant, i.e., compliant with the Payment Card Industry Data Security Standard (PCI DSS), an information security standard for organizations that handle cardholder information for the major debit, credit, prepaid, e-purse, ATM, and POS cards, the current version of which is version 2.0 released on Oct. 26, 2010, the entirety of which is incorporated herein by reference for all purposes. According to some implementations, code (e.g., Java script) may be provided for use with API 308 to enable applications or clients that would otherwise not be PCI compliant to operate in a PCI compliant manner. It should be noted that implementations of API 308 are contemplated that are compliant with a variety of information and financial security standards used throughout the world. References to PCI DSS should therefore not be used to limit the scope of the invention.

According to some implementations, the admin may specify a mode of releasing payment that is not supported by the payment processor being used. For example, the designated payment processor for a particular campaign might be Balanced, while the admin has specified that he'd like the money to be released to his PayPal account. However, Balanced may not directly support such a payment mode. In such instances, the API is configured to facilitate release of the funds using a payment mode supported by the designated payment processor to, for example, an intermediate holding account, and then facilitate release of the funds from the intermediate account via the payment mode specified by the admin, e.g., to the admin's PayPal account. According to some implementations, such an intermediate holding account may be a third party account (e.g., associated with the payment processor or other financial institution) or may be provided as an option with the group-funding platform or API to provide a total solution to the third party merchant.

According to some implementations, each admin has a payment processor as one of his defined attributes. When the API needs to release funds in connection with a particular campaign, it refers to the user specification for that campaign's admin to identify the payment processor and load the appropriate module (e.g., using a “factory model” approach). This allows the API to support a large number of admin users, each of which may select his own payment processor. Similarly, an admin may have a holding account provider and/or a payment distributor as defined attributes to further inform a campaign specification.

According to further implementations, an admin may have multiple associated payment processors each associated with different campaigns. In such instances, the API then uses the admin and the campaign to identify and load the appropriate payment module. This allows an admin the flexibility of selecting a payment processor that best suits a particular campaign. For example, one payment processor might be more advantageous (e.g., cheaper) for a particular monetary goal, while another might support a level of security or reporting that is necessary to satisfy legal and/or regulatory requirements that may be associated with certain types of campaigns.

APIs as described herein may be implemented to work with a variety of modes of payment including, for example, credit cards, Automated Clearinghouse (ACH) payments (e.g., account debiting), online payment (e.g., PayPal, Dwolla, etc.), and various combinations of these, e.g., allowing different modes of payment for different contributors to the same campaign. Implementations supporting different combinations of payment processors to enable various contribution methods are contemplated. Multiple currencies may also be supported allowing application developers and admins considerable flexibility in designing campaigns, e.g., so that a campaign may accept contributions in one or multiple currencies. As mentioned above, such currencies can be conventional national currencies, but may be other types of currencies as well, e.g., virtual currencies (e.g., Bitcoins or currencies associated with a gaming environment or an online community).

According to a particular class of implementations, selection of a payment processor by an admin creating a campaign is guided by payment processor selection logic that allows the admin to select from among a plurality of criteria, and then automatically selects or suggests one or more payment processors that conform to the selected criteria. For example, if you want a payment processor to work within a certain jurisdiction, the logic would select a payment processor that provides that functionality. Another example is where the logic would select a payment processor that operated in desired jurisdictions and offered the cheapest charges for the volume of transactions desired for the campaign. Additional logic would be apparent to one skilled in the art.

According to specific implementations, Unicode descriptions of the various objects defined by the API are supported so that different language versions of campaigns may be implemented. It will be appreciated that the ability to specify particular currencies and to support a wide variety of languages allows the same API to enable a virtually unlimited diversity of group funding applications worldwide.

Particular implementations of a group funding API also enable group funding application functionalities relating to collaboration and communication among the users associated with a particular campaign or goal. Additionally, such functionalities may include, for example, sending of invitations to prospective contributors, messaging (e.g., text, email, etc.) among users involved in a campaign, sharing or expressing approval of campaigns using social media (e.g., Facebook, Twitter, etc.), sending of updates to users associated with a campaign, posting of comments on a campaign web page, etc. As will be understood, these are merely examples of the wide range of collaboration and communication functionalities that may be enabled by various implementations of a group funding API as described herein.

It should now be apparent that a group funding API implemented as described herein may be employed to enable a vast array of group funding applications. The range of possibilities could include, for example, a Nicaraguan coupon site or a Nigerian community action campaign contribution application. Such APIs can enable a wide variety of commercial transactions for existing commerce sites in which a group of users purchase a single item of inventory, e.g., eight people rent a vacation home through VRBO.com; three brothers purchase a single Mother's Day gift on Tiffany.com; etc. A group funding platform might create thousands of admin users and campaigns, millions of contributor users, and thousands of payment types. Alternatively, a group funding application focused on a particular market segment, e.g., vacation rentals, might create only one or a handful of admin users, hundreds or thousands of campaigns, and hundreds of thousands or millions of contributors. Another group funding application might have only one admin, one campaign and 50 contributors. The range of variations will be apparent to those of skill in the art.

According to a particular implementation of a group funding platform that employs an API as described herein, an admin can create a campaign (e.g., by specifying the various parameters using the specifications and methods described in the Crowdtilt API Specs documentation attached hereto), and then test the campaign in a sandbox environment provided by the group funding platform.

In addition to specifying a campaign's tilt amount or monetary goal, an admin may also specify attributes of the payments by each of the contributors to the campaign. For example, the admin could specify a minimum payment amount or a fixed payment amount or both. Various other policies or attributes relating to payments may also be specified. According to a specific implementation of a group funding application, a dynamic pricing policy (represented by optional blocks 242-246 of FIG. 2) may be specified in which the payment amount varies over time or with respect to some other parameter. The dynamic nature means the pricing models offered may include both increasing and decreasing pricing attributes per a defined metric—i.e., the price for something may be configured to go up or down. As an example in which the price goes up, a party promoter has a fixed amount of tickets to sell. They want to offer 100 tickets for sale, with the starting price of $20 for ticket number 1, and an ending price of $50 for ticket number 100. The party promoter can instruct the platform to linearly increase the price for the tickets so that after each ticket sale, the price for the next ticket increases a fixed amount, i.e., so that there are 99 price increases of a fixed number. This notion can be represented by the following formula: (End price−Starting Price)±(Total tickets to sell−1)=The Incremental Ticket Price Increase. In this instance, each person contributing to the campaign is authorized a unique amount, which is then settled. This is but one implementation for increasing price dynamically. Another ability of dynamic pricing is where the price may go down over time. One implementation of this dynamic pricing is where the final amount that is settled for all contributors is equal, and is based upon dividing the goal amount by the total contributors, at which point each contribution must be above a certain amount. The minimum amount is may be defined by the campaign admin. This formula may be represented as follows: Ultimate Settle Amount for Each Contributor=Total Amount Raised±Total Contributors; where being a contributor is conditioned on contributing a minimum amount. Here the whole group equally shares in the benefits for more contributors joining. However, there may be an implementation where contributors share disproportionately. As for a use case, a group might set up a campaign to raise a target amount to pay for a week-long vacation rental house that sleeps up to 16 people. A payment amount could be set initially that achieves the campaign's goal with fewer than 16, e.g., 10, contributors.

Dynamic downward pricing brings authorization and settlement challenges which the API may address. These challenges come into play once the tilt amount is reached. In one implementation, each contributor's contribution is reauthorized for his or her initial authorization amount until the authorization is settled. In another implementation, the reauthorization amount is reduced based upon risk logic. One such implementation is where the tilt amount is reached and reauthorizations are reduced to the value of the amount that would be allocated at that moment to each contributor should the campaign end, e.g., by dividing the total amount raised by the number of contributors. Other implementations would understood by those of skill in the art. The benefits of such an approach become even more apparent as the size of the funding community increases, e.g., 60 person party bus, 1000 person cruise, etc. As would be understood, the redistribution of cost as the number of contributors increases would be a nuisance in the real world for such applications. For example, if an individual was raising money to fund a 1000 person cruise in a conventional way, he might ask contributors to send him a check or cash for a particular amount with a promise of a refund of some portion of the contribution depending on the number of people that end up contributing. The event planner would then need to track and provide those individual refunds to each of the many hundreds contributors. Such an approach might be even more difficult if contributions were made electronically, in which case the event planner would need to deposit funds or provide credits to hundreds of accounts. By contrast, using dynamic pricing as described herein, each contributor is only charged once for the appropriate amount.

According to a particular class of implementations of group funding applications or platforms that employ credit card or ACH debits, payment involves two distinct phases; authorization and charging/debiting. For a campaign in which contributors are not charged unless a tilt amount is reached during the specified duration of the campaign, when a contributor makes a contribution using a credit or debit card, an authorization from the card issuer or bank is obtained (via the associated payment processor(s)) which may have an expiration that is earlier than the end of the campaign. That is, each card issuer or bank authorizes payment for a card for a limited period of time during which the payment is guaranteed. The authorization may last anywhere from minutes to hours to days. Referring again to the example of FIG. 2, when the authorization of a particular payment expires (240), the group funding application gets a reauthorization (216) to ensure that the authorization remains “fresh” until the tilting and/or expiration of the campaign (e.g., 218 and/or 224).

According to a particular implementation, this reauthorization is obtained within a very short period of time after the time of expiration of the original authorization, e.g., within one or more seconds. Because it is statistically unlikely that the reauthorization will be denied because of other debits or credits posting during that short time period, this approach greatly reduces one of the major issues faced by conventional group funding applications and platforms, i.e., contributors to a campaign reconsidering their contribution. When this happens, the group funding provider is forced to either track down the contributors and ask them to renew their contributions, or release less than the expected amount to the admin or beneficiary. Neither of these consequences are desirable from a business perspective in that they can negatively affect the user experience. The reauthorization mechanism greatly reduces the incidence of such events. The actual period between authorizations may vary according to the circumstances and risks of the business.

Some previous approaches to crowd-sourced funding would charge a contributor's credit card or account immediately. But such approaches provided no mechanism for ensuring that some goal was hit before calling in pledges. Other previous approaches would not charge the contributor's card or account but would instead check to see whether there was sufficient room within the relevant credit limit or account balance, and then wait until some later point in time before authorizing and charging the card or account. However, such approaches take the risk that the contributor will have used enough credit in the intervening time to prevent authorization of the amount pledged. As will be appreciated, implementations enabled by the present disclosure have advantages over both of these previous approaches.

According to a particular implementation, there is the ability to cancel an authorization upon a specified event, such as when the tilt amount is not reached and the campaign is expired. The ability to cancel an authorization affords the controls to either cancel an authorization immediately upon the expiration of a non-tilting campaign, or to provide some other time duration to cancel the authorizations.

The manner in which payments are authorized and settled according to various implementations may support dynamic pricing as described above. According to one approach, a campaign may be set up with an initial payment amount for which payment is authorized for each contributor. This initial payment amount can be thought of as the maximum that a contributor would be charged if the campaign tilts. Once the target amount of the campaign has been reached (e.g., there are sufficient funds to cover a 1000 person cruise) the campaign can be considered tilted, but the existing authorizations may not be settled at that point. Instead, additional contributions may be received and authorized until the campaign expires or is otherwise terminated. And as these additional contributions are received, the amount that individual contributors will ultimately be charged may be adjusted according to a dynamic pricing model specified by the admin. For example, the dynamic pricing model might specify that all contributors be charged a pro rata share of the campaign's goal amount or a combination of that, but not less than $X. Alternatively, and as mentioned above, the dynamic pricing model might weight the amounts corresponding to individual contributors according to any of a variety of schemes (e.g., charged contributions might be larger for later contributors). Once the campaign expires, each contributor is charged only her or his adjusted payment amount regardless of the currently authorized payment amount for that contributor.

The manner in which payment authorizations are handled to support dynamic pricing may vary for different implementations. For example, the initial payment amount, and therefore the payment amount for which authorization is obtained for each contributor, may not change over the duration of the campaign. That is, regardless of whether the campaign's target amount has been reached or exceeded, the same payment amount is authorized for each successive contributor. According to this approach, any necessary payment reauthorizations would be for the same amount, and it is only when the campaign expires that each contributor is charged an adjusted payment amount according to the specified dynamic pricing model. Such an approach would mitigate the risk of contributors pulling out, or payment reauthorizations or settlements failing for some contributors.

Alternatively, the requested payment amount, payment authorization amount and/or reauthorization amount may vary over the duration of the campaign, e.g., they might be determined with reference to the adjusted payment amount. According to an example of such an approach, payment authorizations for some initial set of contributors would correspond to the initial payment amount until the target amount for the campaign is reached. At that point, the requested payment amount and the payment authorization amount for subsequent contributors may be reduced to reflect the adjusted payment amount. This reduction may be done in a granular fashion which reflects the adjusted payment amount in near-real time, or in steps as the adjusted payment amount passes through one or more thresholds. Any necessary payment reauthorizations may be for the original payment authorization amount, or may also be reduced in a similar manner with reference to the adjusted payment amount. Other variations will be understood by those of skill in the art.

It should be noted that at least some of the examples described herein contemplate various “cloud computing” implementations. The term “cloud computing” refers to computing models for enabling ubiquitous, convenient, on-demand network access to a shared pool of computing resources (e.g., networks, servers, storage, applications, and services). Cloud-based services are rapidly becoming the primary way in which services are provided to businesses and consumers over the Internet and the World Wide Web. The scope of the invention should therefore not be limited to any particular configuration of computing resources.

According to a particular class of implementations, an API having the functionalities described herein is implemented in Perl, a general-purpose programming language originally developed for text manipulation, and now used for a wide range of tasks including system administration, web development, network programming, and GUI development. The latest major stable revision is 5.16, released in May 2012. The data format for these implementations is the JavaScript Object Notation (JSON) format described in RFC 4627 dated July 2006, the entirety of which is incorporated herein by reference for all purposes.

More particularly, this class of implementations is implemented in accordance with at least some of the guiding principles embodied by the REST (REpresentational State Transfer) computing paradigm. The currently evolving notion of a “RESTful” system is based on the doctoral dissertion of Roy Thomas Fielding entitled Architectural Styles and the Design of Network-based Software Architectures, University of California, Irvine (2000), the entirety of which is incorporated herein by reference for all purposes. Although there is, as of yet, no ratified standard, a RESTful system generally observes a set of principles that define how Web standards such as HTTP and URLs may be used to facilitate heterogeneous application-to-application communication. Generally speaking, REST relates to resource-based systems in which URLs refer to the resources and HTTP methods, e.g., “GET,” “POST,” “PUT,” or “DELETE,” are used to manipulate these resources.

According to a specific class of embodiments, the API defines a specific set of responses for an application's various software components to the HTTP methods. That is, the API defines a set of rules for how it and the various software components with which it interacts operate on the contents of a query for each of the different methods. A list of HTTP methods for a particular implementation is provided in the attached Crowdtilt API Specs documentation referenced above. Some implementations employ HTTPs (the secure version of HTTP) to obscure important information from potentially malicious third parties. For additional information on RESTful systems, please refer to A Brief Introduction to REST posted by Stefan Tilkov on infoq.com on Dec. 10, 2007, the entirety of which is incorporated herein by reference for all purposes.

In addition, and according to some embodiments, authorization in some steps of some system flows may be achieved in accordance with Basic Authentication over SSL which, in the context of an HTTP transaction, is a method for an HTTP user agent to provide a user name and password when making a request. Other forms of authentication (e.g., OAuth) may also be used for a given application.

It should be noted that, despite references to particular computing paradigms and software tools herein, the computer program instructions with which embodiments of the invention may be implemented may correspond to any of a wide variety of programming languages, software tools and data formats, and be stored in any type of volatile or nonvolatile, non-transitory computer-readable storage medium or memory device, and may be executed according to a variety of computing models including, for example, a client/server model, a peer-to-peer model, on a stand-alone computing device, or according to a distributed computing model in which various of the functionalities may be effected or employed at different locations. In addition, reference to particular protocols herein are merely by way of example. Suitable alternatives or those later developed known to those of skill in the art may be employed without departing from the scope of the invention.

While the invention has been particularly shown and described with reference to specific embodiments thereof, it will be understood by those skilled in the art that changes in the form and details of the disclosed embodiments may be made without departing from the spirit or scope of the invention. For example, it should be noted that, while the APIs described herein are an efficient way to implement the various application and platform functionalities described herein, not all of the described functionalities require such an underlying API. For example, dynamic pricing, payment reauthorization, campaign tilting, and support of multiple payment processors are examples of such functionalities. Others will be apparent to those of skill in the art.

Finally, although various advantages, aspects, and objects of the present invention have been discussed herein with reference to various embodiments, it will be understood that the scope of the invention should not be limited by reference to such advantages, aspects, and objects.

What is claimed is:

1. A group funding application programming interface (API), comprising at least one non-transitory computer-readable medium having computer program instructions stored therein which, when executed by one or more computing devices, cause the one or more computing devices to:
create a group funding campaign by which a population of users can contribute payments using client devices operating in a computing network;
select one or more payment processors from among a plurality of payment processors operating in the computing network to facilitate authorization and charging of the payments contributed by the users;
specify a tilt amount that triggers charging of authorized ones of the payments via the computing network when a total of the authorized payments meets or exceeds the tilt amount; and
specify a reauthorization mechanism by which one or more of the authorized payments are reauthorized via the computing network after expiration of the one or more authorized payments.

2. The group funding API of claim 1, wherein the computer program instructions are further configured to cause the one or more computing devices to select a payment type for the payments from among a fixed payment, a minimum payment, or a contributor-specified payment.

3. The group funding API of claim 1, wherein the computer program instructions are configured to cause the one or more computing devices to select multiple payment processors from among the plurality of payment processors to facilitate authorization and charging of the payments for the campaign.

4. The group funding API of claim 1, wherein the computer program instructions are further configured to cause the one or more computing devices to create one or more additional group funding campaigns that are also supported by one or more of the payment processors.

5. The group funding API of claim 4, wherein creation of the group funding campaign and creation of the one or more additional group funding campaigns are initiated by the same user.

6. The group funding API of claim 4, wherein the group funding campaign and the one or more additional group funding campaigns are independent.

7. The group funding API of claim 1, wherein the reauthorization mechanism initiates reauthorization of each expired authorized payment within a period of time during which it is statistically unlikely that reauthorization will be denied.

8. The group funding API of claim 1, wherein the computer program instructions are further configured to cause the one or more computing devices to specify a dynamic pricing policy by which a specified payment amount for the campaign varies according to one or more parameters.

9. The group funding API of claim 8, wherein the one or more parameters include one or more of time, previous contributions, or number of contributors.

10. The group funding API of claim 8, wherein the dynamic pricing policy specifies different payment amounts according to one or more triggers.

11. The group funding API of claim 1, wherein the computer program instructions are further configured to cause the one or more computing devices to specify an expiration of the campaign, wherein the expiration of the campaign corresponds to expiration of a specified time period or a total of the payments meeting or exceeding a specified amount.

12. The group funding API of claim 11, wherein the specified amount is higher than the tilt amount.

13. The group funding API of claim 1, wherein the computer program instructions are further configured to cause the one or more computing devices to cancel the authorized payments if the tilt amount is not met or exceeded by the total of the authorized payments during the campaign.

14. The group funding API of claim 1, wherein the group funding API is compliant with the Payment Card Industry Data Security Standard.

15. The group funding API of claim 1, wherein the computer program instructions are further configured to cause the one or more computing devices to facilitate release of the payments to an intermediate account using a first payment mode supported by one of the one or more selected payment processors, and to facilitate release of the payments within the intermediate account via a second payment mode.

16. The group funding API of claim 15, wherein the campaign administrator specifies the second payment mode.

17. The group funding API of claim 1, wherein the group funding API supports Unicode object descriptions, wherein the group funding API supports multiple currencies, and wherein the computer program instructions are further configured to cause the one or more computing devices to create different language versions of the campaign using the Unicode object descriptions and specifying different ones of the currencies.

18. A group funding system, comprising one or more computing devices configured to use an application programming interface (API) to:
create, via the API, a group funding campaign by which a population of users can contribute payments using client devices operating in a computing network;
select, via the API, one or more payment processors from among a plurality of payment processors operating in the computing network to facilitate authorization and charging of the payments contributed by the users;
specify, via the API, a tilt amount that triggers charging of authorized ones of the payments via the computing network when a total of the authorized payments meets or exceeds the tilt amount; and
specify, via the API, a reauthorization mechanism by which one or more of the authorized payments are reauthorized via the computing network after expiration of the one or more authorized payments.

19. The group funding system of claim 18, wherein the one or more computing devices are further configured to select, via the API, a payment type for the payments from among a fixed payment, a minimum payment, or a contributor-specified payment.

20. The group funding system of claim 18, the one or more computing devices are configured to select, via the API, multiple payment processors from among the plurality of payment processors to facilitate authorization and charging of the payments for the campaign.

21. The group funding system of claim 18, wherein the one or more computing devices are further configured to create, via the API, one or more additional group funding campaigns that are also supported by one or more of the payment processors.

22. The group funding system of claim 21, wherein creation of the group funding campaign and creation of the one or more additional group funding campaigns are initiated by the same user.

23. The group funding system of claim 21, wherein the group funding campaign and the one or more additional group funding campaigns are independent.

24. The group funding system of claim 18, wherein the reauthorization mechanism initiates reauthorization of each expired authorized payment within a period of time during which it is statistically unlikely that reauthorization will be denied.

25. The group funding system of claim 18, wherein the one or more computing devices are further configured to specify, via the API, a dynamic pricing policy by which a specified payment amount for the campaign varies according to one or more parameters.

26. The group funding system of claim 25, wherein the one or more parameters include one or more of time, previous contributions, or number of contributors.

27. The group funding system of claim 25, wherein the dynamic pricing policy specifies different payment amounts according to one or more triggers.

28. The group funding system of claim 18, wherein the one or more computing devices are further configured to specify, via the API, an expiration of the campaign, wherein the expiration of the campaign corresponds to expiration of a specified time period or a total of the payments meeting or exceeding a specified amount.

29. The group funding system of claim 28, wherein the specified amount is higher than the tilt amount.

30. The group funding system of claim 18, wherein the one or more computing devices are further configured to cancel, via the API, the authorized payments if the tilt amount is not met or exceeded by the total of the authorized payments during the campaign.

31. The group funding system of claim 18, wherein the group funding system is compliant with the Payment Card Industry Data Security Standard.

32. The group funding system of claim 18, wherein the one or more computing devices are further configured to facilitate, via the API, release of the payments to an intermediate account using a first payment mode supported by one of the one or more selected payment processors, and to facilitate, via the API, release of the payments from the intermediate account via a second payment mode.

33. The group funding system of claim 32, wherein the campaign administrator specifies the second payment mode.

34. The group funding system of claim 18, wherein the API supports Unicode object descriptions, wherein the API supports multiple currencies, and wherein the one or more computing devices are further configured to create, via the API, different language versions of the campaign using the Unicode object descriptions and specifying different ones of the currencies.

35. A computer-implemented method using a group funding application programming interface (API), comprising:
using one or more computing devices, creating, via the API, a group funding campaign by which a population of users can contribute payments using client devices operating in a computing network;
using the one or more computing devices, selecting, via the API, one or more payment processors from among a plurality of payment processors operating in the computing network to facilitate authorization and charging of the payments contributed by the users;
using the one or more computing devices, specifying, via the API, a tilt amount that triggers charging of authorized ones of the payments via the computing network when a total of the authorized payments meets or exceeds the tilt amount; and
using the one or more computing devices, specifying, via the API, a reauthorization mechanism by which one or more of the authorized payments are reauthorized via the computing network after expiration of the one or more authorized payments.

36. The method of claim 35, further comprising selecting, via the API, a payment type for the payments from among a fixed payment, a minimum payment, or a contributor-specified payment.

37. The method of claim 35, wherein selecting the one or more payment processors comprises selecting, via the API, multiple payment processors from among the plurality of payment processors to facilitate authorization and charging of the payments for the campaign.

38. The method of claim 35, further comprising creating, via the API, one or more additional group funding campaigns that are also supported by one or more of the payment processors.

39. The method of claim 38, wherein creation of the group funding campaign and creation of the one or more additional group funding campaigns are initiated by the same user.

40. The method of claim 38, wherein the group funding campaign and the one or more additional group funding campaigns are independent.

41. The method of claim 35, wherein the reauthorization mechanism initiates reauthorization of each expired authorized payment within a period of time during which it is statistically unlikely that reauthorization will be denied.

42. The method of claim 35, further comprising specifying, via the API, a dynamic pricing policy by which a specified payment amount for the campaign varies according to one or more parameters.

43. The method of claim 42, wherein the one or more parameters include one or more of time, previous contributions, or number of contributors.

44. The method of claim 42, wherein the dynamic pricing policy specifies different payment amounts according to one or more triggers.

45. The method of claim 35, further comprising specifying, via the API, an expiration of the campaign, wherein the expiration of the campaign corresponds to expiration of a specified time period or a total of the payments meeting or exceeding a specified amount.

46. The method of claim 45, wherein the specified amount is higher than the tilt amount.

47. The method of claim 35, further comprising canceling, via the API, the authorized payments if the tilt amount is not met or exceeded by the total of the authorized payments during the campaign.

48. The method of claim 35, wherein the method is compliant with the Payment Card Industry Data Security Standard.

49. The method of claim 35, further comprising facilitating, via the API, release of the payments to an intermediate account using a first payment mode supported by one of the one or more selected payment processors, and facilitating, via the API, release of the payments from the intermediate account via a second payment mode.

50. The method of claim 49, wherein the campaign administrator specifies the second payment mode.

51. The method of claim 35, wherein the API supports Unicode object descriptions, and wherein the API supports multiple currencies, the method comprising creating, via the API, different language versions of the campaign using the Unicode object descriptions and specifying different ones of the currencies.
